(19) United States
(12) Patent Application Publication
(10) Pub. No.: US 2024/0364167 A1
(43) Pub. Date: Oct. 31, 2024

(54) INSULATION STRUCTURE

(71) Applicant: HYUNDAI MOBIS CO., LTD., Seoul (KR)

(72) Inventors: Yong Ho KIM, Seoul (KR); Jae Hak LEE, Suwon-si (KR)

(73) Assignee: HYUNDAI MOBIS CO., LTD., Seoul (KR)

(21) Appl. No.: 18/626,609

(22) Filed: Apr. 4, 2024

(30) Foreign Application Priority Data
Apr. 27, 2023 (KR) 10-2023-0055209

(51) Int. Cl. H02K 3/32; H02K 5/04

(52) U.S. Cl. CPC H02K 3/32; H02K 5/04

(57) ABSTRACT

An insulation structure applied to a motor, and more particularly, an insulation structure which may be mounted in a housing and suppresses a corrosion phenomenon by reducing a magnitude of a shaft voltage by blocking an electric field occurring in an end coil, the structure including: a conductive part having one side in contact with the housing, surrounding a bearing having a concentric shaft with a motor shaft, and extending to be parallel to the end coil; and an insulating part in contact with at least a portion of the other side of the conductive part.

### CROSS-REFERENCE TO RELATED APPLICATIONS

This application claims priority under 35 U.S.C. § 119 to Korean Patent Application No. 10-2023-0055209, filed on Apr. 27, 2023, in the Korean Intellectual Property Office, the disclosure of which is incorporated herein by reference in its entirety.

### TECHNICAL FIELD

The following disclosure relates to an insulation structure blocking an electric field occurring in an end coil to reduce a shaft voltage of a motor.

### BACKGROUND

An inverter motor may be a motor driven by regulating the rotation speed of the motor by using a frequency converter. The inverter motor may achieve high energy efficiency and high performance, and may be actively used in various fields because the inverter motor may particularly have the precisely controlled speed and torque. In addition, the motor may have increasing requirements with recent industrial developments. Accordingly, a carrier frequency used by an inverter tends to be increased as a voltage of power supply applied to the motor may be increased.

The inverter motor may control its frequency in several types. Among these types, a pulse width modulation (PWM) type inverter may drive the motor by converting an input voltage to a high frequency signal. The PWM type inverter may precisely control the speed and torque of the motor by modulating a pulse width, may have relatively inexpensive unit costs to be easily mass-produced, and may be used in various fields such as automobiles, ships, and railways.

However, in the PWM type, a common-mode voltage (CMV) generated in the inverter may induce a high-frequency current to a shaft due to a parasitic capacitance component, thus causing a voltage between the shaft and a metal frame. That is, a voltage applied to a stator winding may cause the shaft voltage and shaft current in a rotor and cause a potential difference between the inner and outer rings of a bearing to thus cause a current or a spark, which may result in bearing corrosion. In addition, when a circulating current flows through the bearing and the motor frame due to the corrosion, a feature of the bearing may be gradually deteriorated. Accordingly, noise and vibration may be gradually increased, thus causing a motor failure. Furthermore, a device failure may occur as the bearing is damaged.

To solve this problem, conventional technology uses methods such as applying a ceramic bearing, grounding the shaft by using a brush, or installing a filter or a circuit to reduce the CMV. However, the conventional method may require significantly increased material costs or complex hardware compared to an existing steel ball. Therefore, the conventional method may have problems such as a complex device and increased manufacturing unit costs, and may cause difficulty in maintenance of the motor due to its limited lifespan caused by wear and tear. In addition, even if the motor uses a corrosion prevention structure, the motor using an oil cooling method may have an oil film occurring between the structure and an assembly of a rotor, thus significantly reducing a corrosion prevention effect.

### SUMMARY

An object of the present disclosure is to reduce a risk of corrosion occurring in a bearing by reducing a magnitude of a shaft voltage, and an embodiment of the present disclosure is directed to providing an insulation structure blocking an electric field occurring in an end coil by providing the insulation structure which may shield a space between the end coil and an assembly of a rotor to reduce the shaft voltage.

In one general aspect, provided is an insulation structure which is configured to be disposed in a motor housing and configured to block an electric field occurring in an end coil, which is drawn from each of two shaft ends of a stator in a shaft direction, from being applied to a motor shaft, the insulation structure including: a conductive part having a first side in contact with the motor housing, surrounding a bearing having a concentric shaft with the motor shaft, and extending to be parallel to the end coil; and an insulating part in contact with at least a first portion of a second side of the conductive part.

The at least the first portion of the second side of the conductive part may be accommodated inside the insulating part.

At least one of the conductive part and the insulating part may have a predetermined length in a direction parallel to a shaft direction of the end coil such that the at least one of the conductive part and the insulating part overlaps the end coil by a predetermined area.

An end of the insulation structure may have a length so as to prevent the insulation structure from being in contact with an end of a rotor.

In a cross-section of the insulating part, a length of the insulating part that is adjacent to the end coil may be at least a length to accommodate a portion of the conductive part that overlaps the end coil.

The insulation structure may have a ring shape.

The conductive part may be thinner than the insulating part.

The structure may further include an auxiliary insulation structure extending from an end of the stator in a direction in which the end coil is drawn, wherein the auxiliary insulation structure has an outer peripheral surface surrounded by a shielding insulation paper, and accommodates a conductive material inside.

The auxiliary insulation structure may have an end adjacent to the stator and protruding and extending by a predetermined area in a radial direction of the stator.

The conductive part may be integrated with the motor housing such that the first side may extend from the housing.

### BRIEF DESCRIPTION OF THE DRAWINGS

FIG. 1 is a cross-sectional view of a motor with an insulation structure of the present disclosure.

FIG. 2 is a perspective view of the insulation structure of the present disclosure.

FIG. 3 is an exploded perspective view of the insulation structure of the present disclosure.

FIG. 4 is an electric field flowchart of the motor with the insulation structure of the present disclosure.

FIG. 5 is a cross-sectional view of a motor with the insulation structure and an auxiliary insulation structure of the present disclosure.

### DETAILED DESCRIPTION

Hereinafter, the technical spirit of the present disclosure will be described in more detail with reference to the accompanying drawings. Prior thereto, terms or words used in the specification and claims are not to be construed as a general or dictionary meaning, and are to be construed as meanings and concepts meeting the technical spirit of the present disclosure based on a principle that the inventors may appropriately define the concepts of terms in order to describe their inventions in best mode.

Therefore, configurations described in the embodiments and accompanying drawings of the present disclosure do not represent all of the technical spirits of the present disclosure, and are merely the most preferable embodiments. Therefore, the present disclosure should be construed as including all the changes and substitutions included in the spirit and scope of the present disclosure at the time of filing this application.

Hereinafter, the technical spirit of the present disclosure will be described in more detail with reference to the accompanying drawings. The accompanying drawings are only examples illustrated in order to describe the technical idea of the present disclosure in more detail. Therefore, the technical spirit of the present disclosure is not limited to the forms of the accompanying drawings.

An insulation structure 100 of the present disclosure may prevent an electric field of an end coil 31, which is drawn from each of two shaft ends of a stator 30, from being applied to a motor shaft 20. That is, the structure 100 may serve to block the electric field from an assembly of a coil interpolated in the stator 30 so as not to be transmitted to an assembly of a rotor 40. Accordingly, in the present disclosure, the insulation structure 100 which is disposed in a motor housing 10 and blocks the electric field occurring in the end coil 31, which is drawn from each of the two shaft ends of the stator 30 in a shaft direction, from being applied to the motor shaft 20 may include: a conductive part 110 having one side in contact with the housing 10, surrounding a bearing 50 having a concentric shaft with the motor shaft, and extending to be parallel to the end coil 31; and an insulating part 120 in contact with at least a portion of the other side of the conductive part 110.

To describe in more detail, the assembly of the rotor 40 may be coupled to the motor centered on the motor shaft 20, a core of the stator 30 may be disposed around the rotor 40, and a magnet of the rotor 40 may receive a rotor force and be rotated by a magnetic field generated from the stator 30. Here, the motor shaft 20 may be supported by the bearing 50 having fixed two ends, and the bearing 50 may enable a rotation of the motor shaft 20. In addition, a voltage may be applied to a winding of the stator 30 based on a change in the magnetic field of the stator 30. As a result, a shaft voltage may occur in the rotor 40, which may cause a corrosion phenomenon in the bearing, noise and vibration increased due to the corrosion phenomenon, and a bearing failure, thus causing a motor defect. Accordingly, an object of the present disclosure is to reduce a risk of corrosion occurring in the bearing by reducing a magnitude of the shaft voltage, which is a source of the corrosion phenomenon, and may prevent the corrosion by blocking the electric field occurring in the end coil 31 by shielding a space between the end coil 31 and the rotor 40 by using the insulation structure 100.

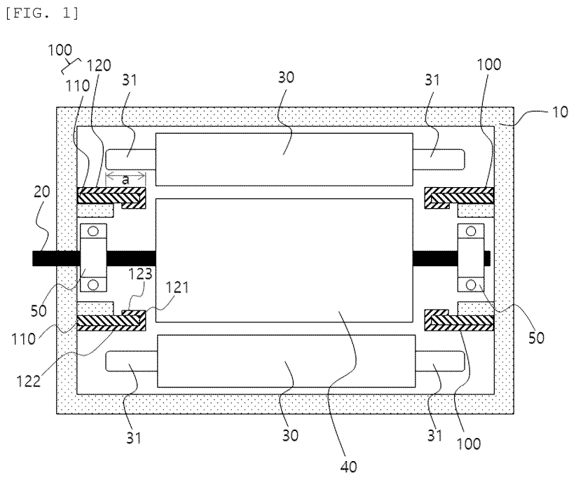

When described with reference to FIG. 1, the insulation structure 100 of the present disclosure may prevent the electric field occurring in the end coil 31 from being applied to the motor shaft 20. The insulation structure 100 may extend from the housing 10 and block a space between the end coil 31 and the bearing 50, thus implementing a shielding shape. The insulation structure 100 may include the conductive part 110 and the insulating part 120, the conductive part 110 may be connected from the housing 10, and the insulating part 120 may be in contact with a portion of the conductive part 110.

When described in more detail with reference to FIGS. 1 to 3, the insulation structure 100 may have a length extending in a shaft direction of the motor shaft 20. That is, each of the conductive part 110 and the insulating part 120 may have a predetermined length in the shaft direction of the end coil 31. The conductive part 110 may have a length extending to block the space between the end coil 31 and the bearing 50, and extend in a direction parallel to the end coil 31 while surrounding the bearing 50. The conductive part 110 may have one side in contact with the housing 10, and its one side may thus be connected to a wall surface of the housing 10. In addition, the insulating part 120 may be in contact with the other side of the conductive part 110, and preferably be in contact with an outer peripheral surface of the conductive part 110. In particular, it is preferable that at least a predetermined area is formed on an outer surface of the conductive part 110 that is adjacent to the end coil 31 to surround a portion of the conductive part 110. In the insulation structure 100 of the present disclosure, it is preferable that the conductive part 110 and the insulating part 120 are in contact with each other, the conductive part 110 is disposed while being in contact with the housing 10, and the insulating part 120 may be disposed to be adjacent to the rotor 40 disposed in the center of the housing 10. Here, the conductive part 110 or the insulating part 120 is not limited to any specific shape as long as the conductive part 110 is in contact with the housing 10, the insulating part 120 is in contact with the other side of the conductive part 110, and the conductive part 110 and the insulating part 120 are connected with each other. The conductive part 110 may be made of an electrically conductive material, for example, aluminum or a material of housing 10. The insulating structure 120 may be made of a material that does not conduct electricity, and may be made of a material selected from materials such as polyphenylene sulfide (pps) or plastic, for example. The insulation structure of the present disclosure may have a simple composition and use inexpensive materials, may thus be manufactured with reduced product unit costs, mass-produced, and applied to various types of motors.

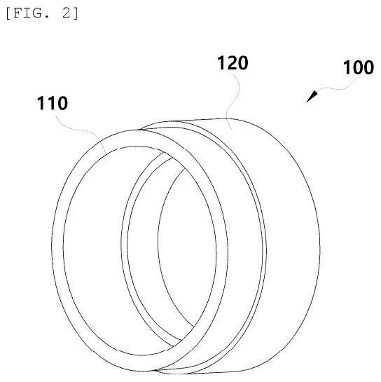

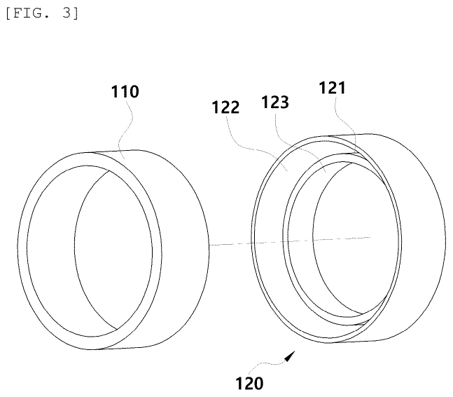

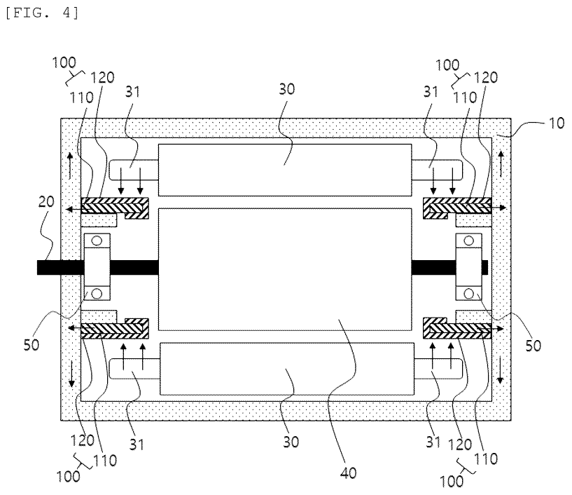

Referring to FIGS. 2 and 3, the insulation structure 100 according to an embodiment of the present disclosure may accommodate at least a portion of the other side of the conductive part 110 inside the insulating part 120. That is, an outer surface of the other side of the conductive part 110 may be in contact with an inner surface of the insulating part 120. Accordingly, each of the insulating part 120 and the conductive part 110 may have the length extending to be parallel to the shaft direction, a diameter of the insulating part 120 may be larger than a diameter of the conductive part 110, and the conductive part 110 may be in surface-contact with the inside of the insulating part 120. Alternatively, the insulating part 120 may have a locking protrusion formed therein, the other side end of the conductive part 110 is caught by the locking protrusion, and the insulating part 120 and the conductive part 110 are coupled with each other. Alternatively, the insulating part 120 may have a groove 121 formed inside and capable of accommodating the conductive part 110 therein, the groove 121 may be formed at the other end of the insulating part 120 that is formed therein, the other side of the conductive part 110 is inserted into the groove 121, and the insulating part 120 and the conductive part 110 may thus be coupled with each other. That is, the insulating part 120 may include the groove 121 having a U-shaped cross-section. Accordingly, as the other side of the conductive part 110 is inserted into the groove 121, the insulating part 120 may surround the other side of the conductive part 110. Here, it is preferable that a size of the groove 121 corresponds to a size of the other side of the conductive part 110, and the groove 121 accommodates the conductive part 110. Accordingly, when described with reference to FIG. 4, the electric field occurring in the end coil 31 may be induced to be moved to the housing 10 connected to a conductor of the insulation structure 100 through the conductor, thus insulating between the end coil 31 and the conductor. Therefore, the insulation structure 100 may be easily manufactured by having a simple structure, may have a wide application range by being coupled to the housing 10 of various types, and may maximize a shaft voltage reduction effect by having a good insulation effect.

The insulation structure 100 may surround the bearing 50 and dispose the insulating part 120 on the outer peripheral surface, thereby blocking the electric field occurring in the end coil 31 from being applied to the bearing 50. The plurality of insulation structures 100 may be provided to correspond to the number of bearings 50 disposed in the housing 10, and may respectively surround the bearings 50. The number of the insulation structures 100 may be determined based on need. As long as the insulation structure 100 surrounds the bearing 50 and has the length, the insulation structure 100 may have various cross-sectional shapes such as a square or a polygon. The insulation structure 100 may have a ring shape in an embodiment of the present disclosure. It is preferable that each of the conductive part 110 and the insulating part 120 has the ring shape with a central hole, accommodates the bearing 50 inside, and is coupled to the housing 10. The ring-shaped insulation structure 100 may correspond to an outer surface shape of the bearing 50, and thus be easily applied to an internal structure of the housing 10. The insulation structure 100 of the present disclosure may be assembled to and installed in the housing 10. That is, the conductive part 110, which is one side of the insulation structure 100, may be connected to and installed in the housing 10. Here, when the bearing 50 is coupled to be adjacent to a cover of the housing 10, the insulation structure 100 may be assembled and installed to be adjacent to the cover of the housing 10. Accordingly, even though the housing 10 has a complex structure, the insulation structure 100 of the present disclosure may be easily installed by being simply inserted into the housing and having a free installation position, and thus be easily assembled to and installed in the housing 10 of various types and shapes. In addition, it is preferable that the insulation structure 100 accommodates the bearing 50 inside, and its extending length is disposed between the stator 30 and the assembly of the rotor 40. In particular, it is preferable that the insulation structure 100 is disposed to block the end coil 31 from the rotor 40.

The insulation structure 100 may preferably have at least the length for blocking the space between the end coil and the bearing 50. In more detail, the end coil 31 may be drawn by a predetermined length from the end of the stator 30 in a direction parallel to a central shaft. Here, a total length of the insulation structure 100 in which the conductive part 110 and the insulating part 120 are coupled with each other may preferably block the space between the end coil 31 and the motor shaft 20 or the bearing 50. That is, the conductive part 110 may have one side in contact with and extending from the housing 10, and the insulating part 120 may be formed on the other side of the conductive part 110. Accordingly, the other end of the insulating part 120 may preferably have the length for the other end to be adjacent to the end of the stator 30. Accordingly, referring to FIG. 1, at least one of the conductive part 110 and the insulating part 120 may have the predetermined length in a direction parallel to the shaft direction of the end coil 31, the length enabling the part 110 or 120 to overlap the end coil 31 by a predetermined area “a”. Here, the extending length of the insulation structure 100 may be disposed within a radius of the rotor 40. In this case, in order not to interfere with a rotation of the rotor 40, it is preferable that the insulation structure 100 has one end extending from the housing 10, and the other end having a length or less within a range for preventing the insulation structure 100 from being in contact with an end of the rotor 40. In addition, when the extending length of the insulation structure 100 is disposed within a radius of the stator 30, the other end of the insulation structure 100 may have a length or less within a range in which the other end is in contact with the end of the stator 30. In addition, when the extending length of the insulation structure 100 is disposed between the stator 30 and the rotor 40, the other end is not limited to any specific length as long as the other end is long enough not to interfere with the magnetic field generated in the stator 30. In addition, the conductive part 110 may be thinner than the insulation structure 100.

Here, a cross-section length of the insulating part 120 that is adjacent to the end coil and a cross-section length of the insulating part 120 that is adjacent to the motor shaft 20 may be different from each other. When described in more detail according to an embodiment with reference to FIGS. 1 and 3, the insulating part 120 may include the groove 121 formed inside the other end and accommodating the one side of the conductive part 110, and include an inner peripheral surface 123 and an outer peripheral surface 122 having the same length or different lengths based on the groove 121. Here, the inner peripheral surface 123 may be in contact with an inner surface of the conductive part 110, that is, its surface that is adjacent to the motor shaft 20, and the outer peripheral surface 122 may be in contact with an outer surface of the conductive part 110, that is, its surface that is adjacent to the stator 30. Here, the outer peripheral surface 122 of the insulating part 120 may be disposed to be adjacent to the end coil 31. It is preferable that in the insulating part 120, the cross-section length of the insulating part 120 that is adjacent to the end coil, which is the length of the outer peripheral surface 122, is at least a length for accommodating the area “a”, that is, a portion of the conductive part 110 that overlaps the end coil 31. In more detail, the conductive part 110 may extend from the housing 10 to the other side. Here, the end coil 31 and the conductive part 110 may be adjacent to each other and disposed to be parallel to each other. Accordingly, it is preferable that the insulating part 120 is disposed to block the electric field occurring in the end coil 31 from being applied to the conductive part 110, the insulating part 120 is coupled to the other side of the conductive part 110, and the outer peripheral surface 122 of the insulating part 120 has at least a length within a range for accommodating the length of the conductive part 110 that overlaps the end coil 31 as much as possible in order to block a space between the end coil 31 and the conductive part 110. The length of the inner peripheral surface 123 of the insulating part 120 may be the same as or different from the length of the outer peripheral surface 122.

The insulation structure 100 of the present disclosure may be an independent device in which the conductive part 110 and the insulating part 120 are coupled with each other. Here, the insulation structure 100 may be installed in the housing 10 by coupling a portion of the conductive part 110 to the housing 10. In more detail, the conductive part 110 may be inserted around the bearing 50, and the insulation structure 100 may thus be disposed to surround the outside of the bearing 50, and installed to block a space between the motor shaft 20 and the stator 30. In addition, the insulation structure 100 of the present disclosure may be integrated with the housing 10. Here, at least the conductive part 110 of the insulation structure 100 may be made of the same material as that of the housing 10, and may be integrated with the housing 10, and the insulating part 120 may then be assembled to the conductive part 110 by being inserted into the outer surface of the conductive part 110. That is, the conductive part 110 may extend in the other direction from the portion of the housing 10 where the bearing 50 is disposed. Alternatively, the conductive part 110 and the insulating part 120 may be integrated with each other, and then extend from the housing 10. It may be confirmed from an analysis model that when applying the insulation structure 100 of the present disclosure, a surface charge of the rotor 40 is reduced by 74% compared to before the application. Accordingly, it may be seen that the insulation structure 100 of the present disclosure effectively reduces the shaft voltage.

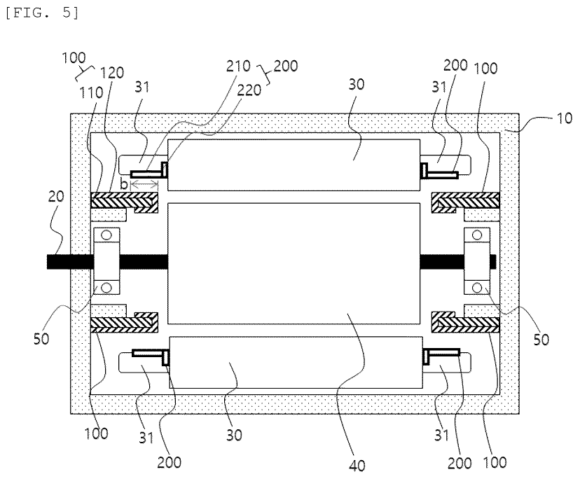

When described with reference to FIG. 5, the insulation structure 100 of the present disclosure may further include an auxiliary insulation structure 200 extending from the end of the stator 30 in the direction in which the end coil 31 is drawn. The auxiliary insulation structure 200 may be a device disposed on inner side of the end coil 31 (that is adjacent to the motor shaft) to reinforce a shielding structure between the end coil 31 and the motor shaft 20. The auxiliary insulation structure 200 may have an outer peripheral surface surrounded by a shielding insulation paper 210, and accommodate a conductive material 220 inside. In addition, the auxiliary insulation structure 200 may extend from the end of the stator 30 in the direction in which the end coil is drawn, have the other end in contact with the end of the stator 30, and have a length extending to its one side. The auxiliary insulation structure 200 may have a rod shape with a predetermined length. Alternatively, the auxiliary insulation structure 200 may have an end on the other side, adjacent to the stator 30, and protruding and extending by a predetermined area in a radial direction of the stator 30. That is, the auxiliary insulation structure 200 may have an L-shaped cross-section. The shielding insulation paper 210 may be water. The auxiliary insulation structure 200 may have a length corresponding to the length of the drawn end coil 31, and have a section “b” in which the insulating part 120 of the insulation structure 100 overlaps the auxiliary insulation structure 200 by a predetermined area. Therefore, the electric field occurring in the end coil 31 may be blocked more strongly through the overlapping section “b”, thereby minimizing the shaft voltage to maximize the shaft voltage reduction.

As set forth above, the insulation structure of the present disclosure as configured above may be the shielding structure blocking the electric field occurring in the end coil to reduce the magnitude of the shaft voltage. The insulation structure may minimize the vibration or the noise by preventing the corrosion phenomenon by reducing the shaft voltage, reducing the unit costs by using the inexpensive steel bearing ball instead of the expensive ceramic bearing ball, and reducing the production costs and the management and maintenance costs by preventing the bearing failure and extending the bearing lifespan.

Hereinabove, although the present disclosure has been described by specific matters such as the detailed components, the embodiments and the accompanying drawings, which are provided only for assisting in comprehensive understanding of the present disclosure. Therefore, the present disclosure is not limited to the embodiments, and various modifications and changes may be made by those skilled in the art to which the present disclosure pertains from this description.

Therefore, the spirit of the present disclosure should not be limited to these embodiments, and the following claims and all modifications equal or equivalent to the claims are intended to fall within the scope and spirit of the present disclosure.

What is claimed is:

1. An insulation structure configured to be disposed in a motor housing and configured to block an electric field occurring in an end coil, which is drawn from each of two shaft ends of a stator in a shaft direction, from being applied to a motor shaft, the insulation structure comprising:
a conductive part having a first side in contact with the motor housing, surrounding a bearing having a concentric shaft with the motor shaft, and extending to be parallel to the end coil; and
an insulating part in contact with at least a first portion of a second side of the conductive part.

2. The insulation structure of claim 1, wherein the at least the first portion of the second side of the conductive part is accommodated inside the insulating part.

3. The insulation structure of claim 2, wherein at least one of the conductive part and the insulating part has a predetermined length in a direction parallel to a shaft direction of the end coil such that the at least one of the conductive part and the insulating part overlaps the end coil by a predetermined area.

4. The insulation structure of claim 3, wherein an end of the insulation structure has a length so as to prevent the insulation structure from being in contact with an end of a rotor.

5. The insulation structure of claim 3, wherein in a cross-section of the insulating part, a length of the insulating part that is adjacent to the end coil is at least a length to accommodate a portion of the conductive part that overlaps the end coil.

6. The insulation structure of claim 1, wherein the insulation structure has a ring shape.

7. The insulation structure of claim 1, wherein the conductive part is thinner than the insulating part.

8. The insulation structure of claim 1, further comprising an auxiliary insulation structure extending from an end of the stator in a direction in which the end coil is drawn,
wherein the auxiliary insulation structure has an outer peripheral surface surrounded by a shielding insulation paper, and accommodates a conductive material inside.

9. The insulation structure of claim 8, wherein the auxiliary insulation structure has an end adjacent to the stator and protrudes and extends by a predetermined area in a radial direction of the stator.

10. The insulation structure of claim 1, wherein the conductive part is integrated with the motor housing such that the first side extends from the housing.
